(19) United States
(12) Patent Application Publication
(10) Pub. No.: US 2008/0087156 A1
(43) Pub. Date: Apr. 17, 2008

(54) MOUTHPIECE WITH A REPLACEABLE BITE PLATE

(75) Inventor: Allen Theodore WANNE, Bellingham, WA (US)

Correspondence Address: GOTTLIEB RACKMAN & REISMAN PC, 270 MADISON AVENUE, 8TH FLOOR, NEW YORK, NY, 10016-0601, US

(73) Assignee: Wanne, Inc., Bellingham, WA (US)

(21) Appl. No.: 11/550,047

(22) Filed: Oct. 17, 2006

(51) Int. Cl. G10D 7/02

(52) U.S. Cl. 84/384

(57) ABSTRACT

A mouthpiece is formed with a bite plate seat receiving a bite plate. The bite plate is maintained in place with a releasable adhesive. Therefore, a musician can replace the bite plate at will and does not have to worry about depressions in the bite area of the mouthpiece caused by his teeth during playing.

### RELATED APPLICATIONS

NONE

### BACKGROUND OF THE INVENTION

A. Field of Invention

This invention pertains to musical instruments with removable mouthpieces, and more particularly to a novel mouthpiece with a replaceable bit plate.

B. Description of the Prior Art

Woodwind instruments are instruments consisting of a tubular body used to define a column of air. As is well known in the art, sound waves are produced within the column of air and the musical characteristics of the sounds, including pitch, volume and other characteristics are modulated by changing the acoustic characteristics of the column. More specifically, a mouthpiece is attached by a friction fit to an end of the tubular body. The mouthpiece has a cavity in communication with the interior of the tubular body. A reed covers the cavity and is arranged so that when a musician blows through the mouthpiece, the reed oscillates and produces vibrations which are then propagated through the cavity in the mouthpiece to the tubular body. The reed is secured to the mouthpiece by a metal band known as the ligature. The mouthpiece is formed with a bite area disposed at a location generally opposite to said reed.

When a musician puts his mouth around the tip of the mouthpiece of an instrument (such as a saxophone) to blow air through the mouthpiece his upper teeth rest upon the bite area of the mouthpiece. While the instrument is played, the mouthpiece vibrates causing it to knock repeatedly against the upper teeth. This vibration can damage both the teeth of the musician and the bite area as well as affect the musicians control and resultant sound while playing.

There have been some attempts to solve this problem, for example by forming the mouthpiece with a depression or seat, making a bite plate of a softer compound than the mouthpiece itself and then permanently bonding said mouth plate into said seat. Because it is made of a soft material, the bite plate alleviates the effects of vibrations of the mouthpiece on the teeth. The bite plate is recessed into the mouthpiece such that it remains flush with the remaining bite area of the mouthpiece.

However, the above-described solution is very unsatisfactory because over time the vibrations result in a depression being formed in the bite plate. As this depression becomes larger then larger, the mouthpiece becomes uncomfortable, and the musician must improvise by shipping the mouthpiece to a qualified professional who can fill the depression with various materials or replace the warn bite plate entirely. The materials used to fill the depression usually fall out or a depression is formed in them as well. Moreover, even when professionally done it is difficult to fill the depression accurately so that the surface of the bite area remains flush. Hence the most common solution is to have the bite plate completely replaced. This entails grinding out the original bite plate, reforming a new one with a two part epoxy or hard rubber, finishing the bite area of the mouthpiece such that the new bite plate is flush with it, then finally replating the ENTIRE mouthpiece as all the plating on the bite area was removed while attempting to level the bite plate to the bite area.

### SUMMARY OF THE INVENTION

A mouthpiece constructed in accordance with this invention includes a tubular body with two opposed ends, a cavity covered by a reed on one end, and a seat of predetermined size and shaped formed in the bite area at said same end. A removable bite plate is sized and shaped to fit into the seat so that its top surface is flush with the top surface of the mouthpiece. The plate is made of a relatively soft and flexible material such as polyurethane and is coated with a releasable adhesive so that the plate can be easily removed and replaced with another plate at anytime by the user himself.

### BRIEF DECRIPTION OF THE DRAWINGS

FIG. 1A shows an orthogonal view of a prior art mouthpiece for a musical instrument;

FIG. 1B shows the prior art mouthpiece with a depression;

FIG. 2 shows a side view of a mouthpiece constructed in accordance with this invention with the bite plate being replaced; and

FIG. 3 shows a side view of the mouthpiece of FIG. 2 without the bite plate.

### DETAILED DESCRIPTION OF THE INVENTION

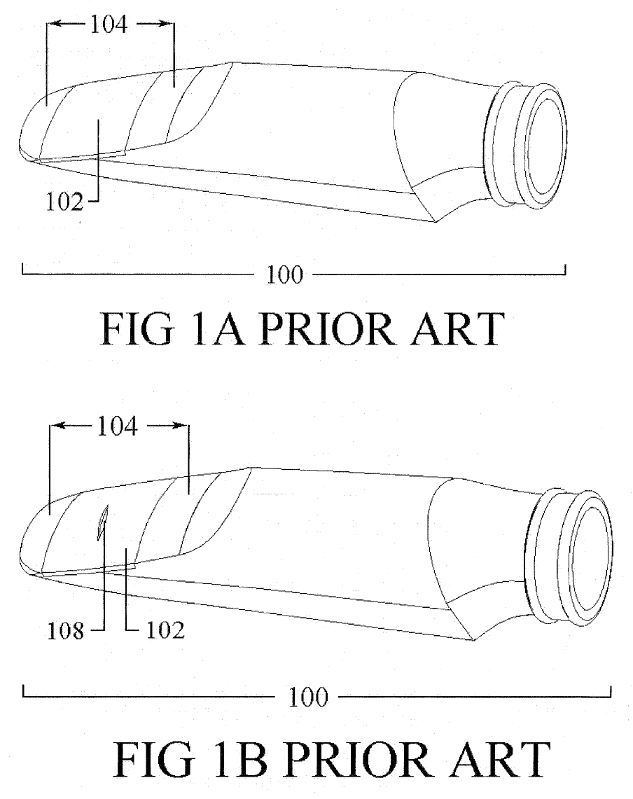

FIGS. 1A and 1B show a typical prior art mouthpiece 100 with an insert 102 disposed in a recess in the mouthpiece and flush with a bite area 104. As mentioned above, when a musician puts his mouth around the tip of a mouthpiece 100 his teeth rest upon the bite area 104. Vibration incurred while blowing through the mouthpiece causes the insert 102 to knock against the teeth and eventually a depression 108 is formed in the insert 102. Present attempts to resolve this problem included providing the permanently installed insert 102 from a softer compound than the mouthpiece itself. The compound fills the recess to help alleviate the vibrations on the teeth resting on the area 104.

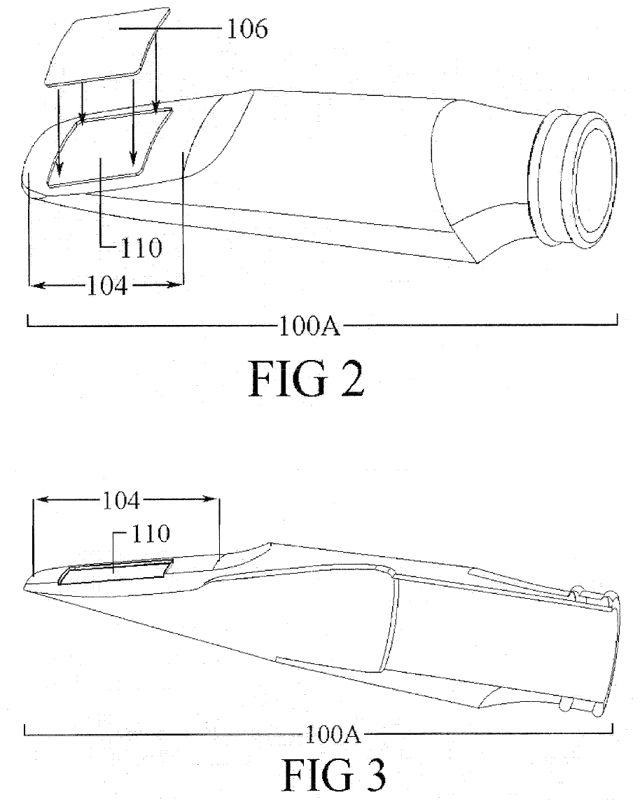

In the present invention shown in FIGS. 2 and 3, mouthpiece body 100A is formed with a small seat 110 of a predetermined size and shape and having a constant depth. In the drawings the depression is shown as being rectangular, and slightly curved, following the shape of the bite area 104, but it can have other shapes as well.

A bite plate 106 is inserted into the seat 110 so that it is flush with the bite area 104. Importantly, the bottom of the plate 106 and/or the seat 110 is coated with a release-type adhesive that allows the plate 106 to be removed and replaced with another plate of identical size and shape.

In one embodiment of the invention, the plate 106 is made of a peel and stick stock material. For example, the bite plate 106 can be stamped or die-cut from a tape with an adhesive backing. Suitable tapes made of an adhesive-coated polyurethane are available from 3M and other sources. Typically, these tapes come in rolls of ¼″ to 48″ wide and 36 yards long. Once applied, since the plate being only adhesive backed and not permanently glued in, at any point the user can simply peel it out and replace it with another one. This process will also allow the manufacturer to provide bite plates with materials of various densities or having degrees of pliability or softness. Thus, the bite plate can be variably softer than the mouthpiece body or at least the bite area. Alternatively, the bite plate can have the same hardness as the bite plate area. Conceivable, some musicians may even prefer a bite plate that is harder than the bite area. Thus, a musician can buy a single mouthpiece and apply a bite plate having the physical characteristics that he prefers to adjust the feel of his teeth on the mouthpiece. This has never been before possible.

Thus, a mouthpiece is produced in accordance with this invention as follows. First a mouthpiece body is made having a desired physical shape. Importantly, the body of the mouthpiece is formed with the seat 110. Next, bite plates 106 are formed, said bite plates having the size and shape selected so that the plate 106 can fit snugly in seat 110 and its top surface is flush with the rest of the bite area 104. A releasable adhesive is used to secure the bite plate 106 within the seat 110. The bite plate 106 can be made of a hard or a soft material as desired by a musician.

In one embodiment, the bite plate is stamped or die-cut from a continuous tape of material, such as polyurethane, coated with a releasable adhesive.

Numerous modifications can be made to the invention without departing from the scope defined in the appended claims.

I claim:

1. A mouthpiece for a musical instrument comprising:
a mouthpiece body having a bite area with a bite plate seat; and
bite plate positioned in said bite plate seat and being retained therein by a releasable adhesive that allows bite plates to be freely replaced.

2. The mouthpiece assembly of claim 1 wherein said bite plate is made of a material that is softer than said bite plate area.

3. The mouthpiece assembly of claim 1 wherein said bite plate has the same hardness as said bite plate area.

4. The mouthpiece of claim 1 wherein said bite plate is made of polyurethane.

5. A method of making of a mouthpiece for a musical instrument comprising:
forming a mouthpiece body with a bite plate seat; and
attaching a bite plate on the biteplate using a releasable adhesive.

6. The method of claim 5 wherein said bite plate is softer then said mouthpiece body.

7. The method of claim 5 further comprising making said bite plate from an elongated tape coated with said adhesive.

8. The method of claim 7 wherein said tape is made of polyurethane.
